(19) United States
(12) Patent Application Publication
(10) Pub. No.: US 2026/0209402 A1
(43) Pub. Date: Jul. 23, 2026

(54) PROCESS FOR MAKING POLYPROPYLENE USING A SELECTIVITY CONTROL AGENT AND AN ACTIVITY LIMITING AGENT

(71) Applicant: SABIC GLOBAL TECHNOLOGIES B.V., Bergen op Zoom (NL)

(72) Inventors: Abdulrahman Hamdi Al-Beladi, Jubail (SA); Akhlaq Moman, Riyadh (SA)

(21) Appl. No.: 19/140,713

(22) PCT Filed: Nov. 7, 2023
(86) PCT No.: PCT/EP2023/080969

§ 371 Date: Jun. 18, 2025

(30) Foreign Application Priority Data
Dec. 22, 2022 (EP) 22216098.8

(51) Int. Cl. C08F 10/06; C08J 5/18

(52) U.S. Cl. CPC C08F 10/06; C08J 5/18; C08F 2410/01; C08J 2323/12; C08J 2323/14

(57) ABSTRACT

A process for the production of a propylene.

### CROSS REFERENCE TO RELATED APPLICATIONS

This application is a National Stage application of PCT/EP2023/080969, filed Nov. 7, 2023, which claims the benefit of European Application No. 22216098.8, filed Dec. 22, 2022, both of which are incorporated by reference in their entirety herein.

### TECHNICAL FIELD

The present invention relates to a process for the preparation of a composition comprising a propylene-based polymer which is a propylene homopolymer or propylene-ethylene copolymer.

### BACKGROUND

Polymers, like polypropylene, are increasingly used in different demanding applications. At the same time, there is a continuous search for tailored polymers which meet the requirements of these applications, for instance of a high isotacticity.

In addition, in a gas phase polymerization process, the polymerization reactor is cooled by the circulating monomer gasses to maintain a steady operating temperature. However, if the temperature of a growing resin particle approaches the sticking/melting point of the resin, resin sheeting on the reactor walls may occur. Growing resin particles are especially susceptible to overheating if they accumulate at the reactor walls, thereby losing heat-transfer with the circulating monomer gasses, and remaining in close contact with respect to each other. In such instances, particle-particle fusion may occur, followed by reactor sheeting, which, in turn, could cause reactor shutdown.

The currently available catalyst systems fail to address such heat removal concerns in olefin polymerization processes such as ethylene polymerization systems. Therefore, there is a need for a catalyst system having an effective mechanism that substantially reduces catalyst activity within a narrow temperature range and therefore reducing heat generation when the temperature in various parts of the reactor system approaches (co) polymer softening temperature to prevent agglomeration formation and minimizing production disruptions.

WO 2019/094942 and WO 2020/231716 describe he polymerization of propylene or propylene-ethylene copolymers in fluidized bed reactors the presence of a Ziegler-Natta catalyst. However those catalyst systems fail to produce propylene homopolymers or propylene-ethylene copolymer having high isotacticity at high and low temperature.

Therefore, it is the object of the invention to provide a process for the production of propylene homopolymers or propylene-ethylene copolymer having high isotacticity which use a catalyst having an effective mechanism to reduce heat generation to prevent production disruption.

### SUMMARY

This object is achieved by a process for the polymerizing propylene homopolymer or propylene-alpha-olefin copolymer comprising the steps of:
Selecting a propylene monomer and optionally one or more alpha-olefin comonomers;
Selecting one or more catalyst system comprising:
   one or more Ziegler-Natta procatalysts;
   optionally one or more cocatalyst;
   one or more internal donor according to Formula I:

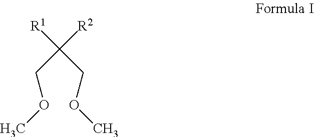

wherein R1 is a secondary alkyl group and R2 is a non-secondary alkyl group having at least 5 carbon atoms, preferably R2 is a non-secondary alkyl group being branched at the 3-position or further positions;
   one or more activator;
   one or more Selectivity Control Agent (SCA);
   one or more Activity Limiting Agent (ALA);
wherein Ziegler-Natta procatalyst is obtain by the following step:
   i) contacting a compound R⁴_{z}MgX⁴_{2-z} with an alkoxy- or aryloxy-containing silane compound to give a first intermediate reaction product, being a solid Mg(OR¹)ₓX¹₂₋ₓ, wherein: R⁴ and R¹ are each a linear, branched or cyclic hydrocarbyl group independently selected from alkyl, alkenyl, aryl, aralkyl, alkoxycarbonyl or alkylaryl groups, and one or more combinations thereof; wherein said hydrocarbyl group may be substituted or unsubstituted, may contain one or more heteroatoms and preferably has from 1 to 20 carbon atoms; X⁴ and X¹ are each independently selected from the group of consisting of fluoride (F—), chloride (Cl—), bromide (Br—) or iodide (I—), preferably chloride; z is in a range of larger than 0 and smaller than 2, being 0<z<2, x is in a range of larger than 0 and smaller than 2, being 0<x<2;
   ii) optionally contacting the solid Mg(OR¹)ₓX¹₂₋ₓ obtained in step i) with at least one activating compound selected from the group formed of activating electron donors and metal alkoxide compounds of formula M¹(OR²)_{v-w}(OR³)_{w} or M²(OR²)_{v-w}(R³)_{w}, to obtain a second intermediate product; wherein M₁ is a metal selected from the group consisting of Ti, Zr, Hf, Al or Si; M₂ is a metal being Si; v is the valency of M¹ or M² and is either 3 or 4; w<v; R² and R³ are each a linear, branched or cyclic hydrocarbyl group independently selected from alkyl, alkenyl, aryl, aralkyl, alkoxycarbonyl or alkylaryl groups, and one or more combinations thereof; wherein said hydrocarbyl group may be substituted or unsubstituted, may contain one or more heteroatoms, and preferably has from 1 to 20 carbon atoms;
   iii) contacting the first or second intermediate reaction product, obtained respectively in step i) or ii), with the halogen-containing Ti-compound; the activator; and the internal electron donor
polymerizing the propylene monomer and optionally the one or more alpha-olefin comonomers, in presence of the catalyst system, whish has been obtained by contacting the Ziegler-Natta procatalyst obtained in step iii) with the optional co-catalyst and the Selectivity Control Agent (SCA) in combination with an Activity Limiting Agent (ALA); via a slurry polymerization process or a gas-phase polymerization process or a solution polymerization process, in one or more reactors;
thereby producing one or more polypropylene
wherein the catalyst system has a loss of at least 35%, preferably 50%, more preferably 75%, even more preferably at least 90%, preferably of catalyst activity when the temperature is increased from 58 to 94° C.

### DETAILED DESCRIPTION

### Propylene-Based Polymer

The polypropylene composition according to the invention comprises a propylene-based polymer which is a propylene homopolymer or propylene-ethylene copolymer, preferably having an ethylene content of less than 1.0 wt % based on the propylene-ethylene copolymer.

Preferably, the propylene-based polymer has a pentad isotacticity of at least 93 wt. %, preferably of at least 96 wt %, wherein the pentad isotacticity is determined using ¹³C NMR on the polymer has been produced under a reaction temperature of 94° C.

Furthermore, the catalyst system according to the invention, allow to obtain the propylene-based polymer according to the invention having an average meso sequence length (MSL) superior or equal to 90 when it has been polymerized at 58° C. and/or superior or equal to 80 when it has been polymerized at 94° C., and/or between 90 and 80 when it has been polymerized in between 58 and 94°.

### Catalyst System

The Catalyst system according to the invention comprising:
one or more Ziegler-Natta procatalysts;
optionally one or more cocatalyst;
one or more internal donor;
one or more activator;
one or more Selectivity Control Agent (SCA);
one or more Activity Limiting Agent (ALA);
   the catalyst system has a loss of least 90%, preferably at least 93.5% of catalyst activity when the temperature is increased from 58 to 94° C.

Preferably, the catalyst is a 9,9-bis(methoxymethyl)fluorene (BMMF) free catalyst.

For purpose of the invention, essentially BMMF-free is defined as the presence of less than 0.0001 wt % of BMMF, preferably 0.00001 wt % of BMMF in the process of the invention Therefore, preferably the process of the invention is essentially BMMF-free.

Preferably, the catalyst is phthalate-free catalyst.

In case a phthalate-free catalyst, such as the described catalyst using a phthalate free internal/external donor, is used, the propylene homopolymer or propylene-ethylene copolymer obtainable by or obtained by the process of the invention is essentially phthalate-free. This is advantageous as more and more consumers try to avoid any contact with phthalates.

### Ziegler-Natta Pro-Catalyst

The process for preparing a procatalyst according to the present invention comprises the following phases:
a) preparing a solid support for the procatalyst;
b) optionally activating said solid support obtained in phase a) using one or more activating compounds to obtain an activated solid support;
c) contacting said solid support obtained in phase a) or said activated solid support in phase b) with a catalytic species wherein phase c) comprises one of the following:
   i. contacting said solid support obtained in phase a) or said activated solid support in phase b) with a catalytic species, an activator, and one or more internal donors to obtain said procatalyst; or
   ii. contacting said solid support obtained in phase A) or said activated solid support in phase b) with a catalytic species, an activator, and one or more internal donors to obtain an intermediate product; or
   iii. contacting said solid support obtained in phase a) or said activated solid support in phase b) with a catalytic species and an activator to obtain an intermediate product;
d) optionally modifying said intermediate product obtained in phase c) wherein phase d) comprises on of the following:
   i. modifying said intermediate product obtained in phase c) with a Group 13- or transition metal modifier in case an internal donor was used during phase c), in order to obtain a procatalyst;
   ii. modifying said intermediate product obtained in phase c) with a Group 13- or transition metal modifier and an internal donor in case an activator was used during phase c), in order to obtain a procatalyst.

More information about the process steps can be found in WO2015185490A1, page 32, line 22 through page 39, line 17 for Phase A, from page 39, line 18 through page 45, line 2 for Phase B, from page 45, line 4 through page 47, line 30 for Phase C, from page 47, line 32 through page 53 line 11 for Phase D. These sections are herewith incorporated by reference.

The process for providing said procatalyst may follow the one describe in WO2021/063930A1 (which in incorporated by reference) and comprises the steps of:
i. contacting a compound R⁴_{z}MgX⁴_{2-z} with an alkoxy- or aryloxy-containing silane compound to give a first intermediate reaction product, being a solid Mg(OR^{a})ₓX¹₂₋ₓ, wherein: Ra is a linear, branched or cyclic hydrocarbyl group independently selected from alkyl, alkenyl, aryl, aralkyl, alkoxycarbonyl or alkylaryl groups, and one or more combinations thereof; wherein said hydrocarbyl group may be substituted or unsubstituted, may contain one or more heteroatoms and preferably has from 1 to 20 carbon atoms; wherein R⁴ is a linear, branched or cyclic hydrocarbyl group independently selected from alkyl, alkenyl, aryl, aralkyl, alkoxycarbonyl or alkylaryl groups, and one or more combinations thereof; wherein said hydrocarbyl group may be substituted or unsubstituted, may contain one or more heteroatoms and preferably has from 1 to 20 carbon atoms, preferably R⁴ is butyl; wherein X⁴ and X¹ are each independently selected from the group of consisting of fluoride (F—), chloride (Cl—), bromide (Br—) or iodide (I—), preferably chloride; z is in a range of larger than 0 and smaller than 2, being 0<z<2, x is an integer between 0 and 2;
ii. optionally contacting the solid Mg(OR^{a})ₓX¹₂₋ₓ obtained in step i) with at least one activating compound selected from the group formed by activating electron donors and metal alkoxide compounds of formula M¹(OR^{b})_{v-w}(OR³)_{w} or M²(OR^{b})_{v-w}(R³)_{w}, preferably ethanol as activating electron donor and titanium tetraethoxide (TET) as metal alkoxide compound, to obtain a second intermediate product; wherein: M¹ is a metal selected from the group consisting of Ti, Zr, Hf, Al or Si; v is the valency of M¹; M² is a metal being Si; v is the valency of M²; Rb and R³ are each a linear, branched or cyclic hydrocarbyl group independently selected from alkyl, alkenyl, aryl, aralkyl, alkoxycarbonyl or alkylaryl groups, and one or more combinations thereof; wherein said hydrocarbyl group may be substituted or unsubstituted, may contain one or more heteroatoms, and preferably has from 1 to 20 carbon atoms; wherein w is smaller than v, preferably v being 3 or 4;
iii. contacting the first or second intermediate reaction product, obtained respectively in step i) or ii), with a halogen-containing Ti-compound and said compound represented Formula I, as the internal electron donor.

### Activator

The activator according to the invention, is an electron-donating compound containing one or more atoms of oxygen (O) and/or nitrogen (N) which is used during the synthesis of the procatalyst (viz. during the addition of the catalytic species to the solid support) and is added prior to or simultaneous with the addition of an internal donor.

Preferably, in some embodiment, the activator is selected from the from the group comprising of benzamides, alkylbenzoates, mono-esters, ethyl acetate, amyl acetate, butyl acetate, ethyl acrylate, methyl methacrylate, isobutyl methacrylate, methylbenzamide, dimethylbenzamide, methylbenzoate, ethylbenzoate, n-propylbenzoate, iso-propylbenzoate, n-butylbenzoate, 2-butylbenzoate, t-butylbenzoate, monoamide, ethyl benzoate, N,N-dimethyl benzamide.

In some embodiment, said activator is a benzamide according to formula X:

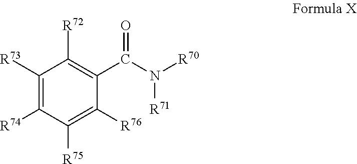

wherein R⁷⁰ and R⁷¹ are each independently selected from hydrogen or an alkyl, and R⁷², R⁷³, R⁷⁴, R⁷⁵, R⁷⁶ are each independently selected from hydrogen, a heteroatom or a hydrocarbyl group, preferably selected from alkyl, alkenyl, aryl, aralkyl, alkoxycarbonyl or alkylaryl groups, and one or more combinations thereof, more preferably wherein R⁷⁰ and R⁷¹ are both methyl and wherein R⁷², R⁷³, R⁷⁴, and R⁷⁵ are all hydrogen, preferably N,N-dimethyl benzamide

### Internal Electron Donor

The internal electron donor according to the invention is a compound according to formula I:

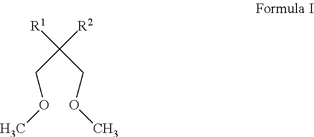

wherein R¹ and R² are each independently selected from the group consisting of alkyl groups having at least three carbon atoms (C3), preferably at most seven carbon atoms (C7), preferably at most six carbon atoms (C6) preferably iso-propyl, iso-butyl, iso-pentyl, cyclopentyl, n-pentyl, and iso-hexyl.

In a specific embodiment, the internal electron donor is 3,3-bis(methoxymethyl)-2,5-dimethylhexane, according to Formula I wherein R¹ is the secondary C3 alkyl iso-propyl and R² is a non-secondary iso-butyl having a branch on the second carbon atom (abbreviated as iPiB, wherein iP stands for iso-propyl and wherein iB stands for iso-butyl, also known as 2-methyl-propyl). This compound iPiB has a chemical formula of C₁₂H₂₆O₂; an exact mass of 202.19 and a molecular weight of 202.34. In a more specific embodiment, iPiB is used as internal donor and/or wherein the activating compound is N,N-dimethylbenzamide.

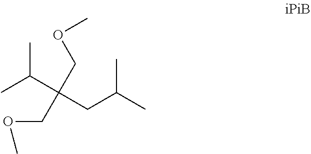

In another embodiment, the internal electron donor is 5,5-bis(methoxymethyl)-2,8-dimethylnonane, according to Formula I wherein R¹ and R² are both iso-pentyl, both being non-secondary and having a branch on the third carbon atom (abbreviated as iPen, wherein iPen stands for iso-pentyl, also known as 3-methyl-butyl). This compound iPen has a chemical formula of C₁₅H₃₂O₂; an exact mass of 244.24 and a molecular weight of 244.42. In a more specific embodiment, iPen is used as internal donor and N,N-dimethylbenzamide is used as activator.

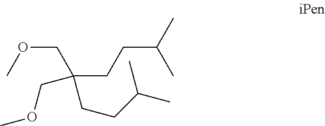 [SMILES: COCC(CCC(C)C)(CCC(C)C)COC]

In another embodiment, the internal electron donor is 3,3-bis(methoxymethyl)-2,6-dimethyl heptane, according to Formula I wherein R¹ is iso-propyl being secondary alkyl and R² is iso-pentyl being non-secondary and having a branch on the third carbon atom (abbreviated as iPiPen, wherein iP stands for iso-propyl and iPen stands for iso-pentyl, also known as 3-methyl-butyl). This compound iPiPen has a chemical formula of C₁₃H₂₈O₂; an exact mass of 216.21 and a molecular weight of 216.37. In a more preferred embodiment of the invention, iPiPen is used as internal donor and/or wherein the activating compound is N, N-dimethylbenzamide.

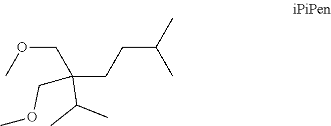

In another embodiment, the internal electron donor is 3,3-bis(methoxymethyl)-2,4-dimethyl-heptane, according to Formula I wherein R¹ is the secondary alkyl iso-propyl and R² is being secondary alkyl 2-pentyl (abbreviated as iP2Pen, wherein iP stands for iso-propyl and 2Pen stands for 2-pentyl). This compound iP2Pen has a chemical formula of C₁₃H₂₈O₂; an exact mass of 216.21 and a molecular weight of 216.37. In a more specific embodiment, iP2Pen is used as internal donor and N,N-dimethylbenzamide is used as activator.

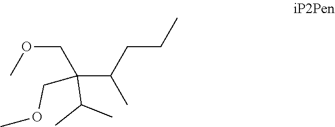

In another embodiment, the internal electron donor is (1-methoxy-2-(methoxymethyl)-5-methylhexan-2-yl)cyclopentane, according to Formula I wherein R¹ is secondary alkyl cyclopentyl and R² is secondary cyclopentyl (abbreviated as CPiPen, wherein CP stands for cyclopentyl and iPen stands for iso-pentyl, also known as 3-methyl-butyl). This compound CPiPen has a chemical formula of C₁₅H₃₀O₂; an exact mass of 242.22 and a molecular weight of 242.40. In a more specific embodiment, CPiPen is used as internal donor and N,N-dimethylbenzamide is used as activator.

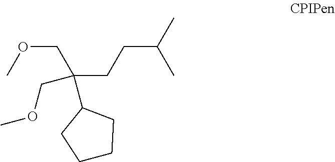 [SMILES: COCC(CCC(C)C)(COC)C1CCCC1]

In another embodiment, the internal electron donor is (1,3-dimethoxypropane-2,2-diyl)dicyclopentane according to Formula I wherein R¹ and R² are both secondary alkyl cyclopentyl (abbreviated as CP, wherein CP stands for cyclopentyl). This compound CP has a chemical formula of C₁₅H₂₈O₂; an exact mass of 240.21 and a molecular weight of 240.39 In a more specific embodiment, CP is used as internal donor and N,N-dimethylbenzamide is used as activator.

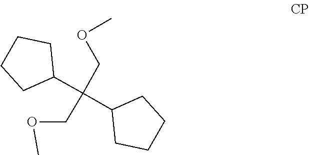 [SMILES: COCC(COC)(C1CCCC1)C1CCCC1]

In another embodiment, the internal electron donor is 3,3-bis(methoxymethyl)-2,7-dimethyloctane, according to Formula I wherein R¹ is the secondary alkyl iso-propyl and R² is non-secondary iso-hexyl with a branch on the third carbon atom (abbreviated as iPiHex, wherein iP stands for iso-propyl and iHex stands for iso-hexyl, also known as 4-methyl-pentyl). This compound iPiHex has a chemical formula of C₁₄H₃₀O₂; an exact mass of 230.22 and a molecular weight of 230.39. In a more specific embodiment, iPiHex is used as internal donor and N,N-dimethylbenzamide is used as activator.

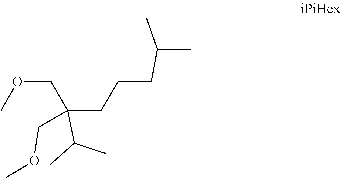 [SMILES: COCC(CCCC(C)C)(COC)C(C)C]

In another embodiment, the internal electron donor is 3,3-bis(methoxymethyl)-2-methyloctane, according to Formula I wherein R¹ is secondary alkyl iso-propyl and R² is non-secondary non-branched n-pentyl (abbreviated as iPnPen, wherein iP stands for iso-propyl and nPen stands for n-pentyl). This compound iPnPen has a chemical formula of C₁₃H₂₈O₂; an exact mass of 216.21 and a molecular weight of 216.37. In a more specific embodiment, iPnPen is used as internal donor and N,N-dimethylbenzamide is used as activator.

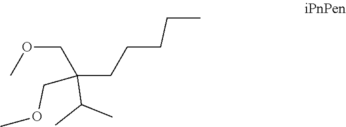

In another embodiment, the internal electron donor is 3,3-bis(methoxymethyl)-2,6-dimethyloctane, according to Formula I wherein R¹ is secondary alkyl iso-propyl and R² is non-secondary branched iso-hexyl having a branch at the third carbon atom (abbreviated as iPiHex, wherein iP stands for iso-propyl and wherein iHex stands for iso-hexyl, also known as 3-methyl-pentyl). This compound iPiHex has a chemical formula of C₁₄H₃₂O₂; an exact mass of 230.22 and a molecular weight of 230.39. In a more preferred embodiment, iPiHex is used as internal donor and/or N,N-dimethylbenzamide is used as activator.

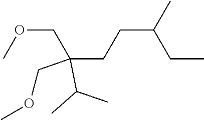 [SMILES: CCC(C)CCC(COC)(COC)C(C)C]

Preferably, according to the invention, the catalyst system is phthalate free. It is preferred to use so-called phthalate free internal donors because of increasingly stricter government regulations about the maximum phthalate content of polymers. In the context of the present invention, ““phthalate-free” means having a phthalate content of less than for example 150 ppm, alternatively less than for example 100 ppm, alternatively less than for example 50 ppm, alternatively for example less than 20 ppm, for example of 0 ppm based on the total weight of the catalyst system. Examples of phthalates include but are not limited to a dialkylphthalate esters in which the alkyl group contains from about two to about ten carbon atoms. Examples of phthalate esters include but are not limited to diisobutylphthalate, ethylbutylphthalate, diethylphthalate, di-n-butylphthalate, bis(2-ethylhexyl)phthalate, and diisodecylphthalate.

Therefore, preferably, the process of the invention is essentially phthalate free.

### Co-Catalyst

The co-catalyst according to the invention may include any compounds known in the art to be used as “co-catalysts”, such as hydrides, alkyls, or aryls of aluminum, lithium, zinc, tin, cadmium, beryllium, magnesium, and combinations thereof. The co-catalyst may be a hydrocarbyl aluminum co-catalyst represented by the formula R203Al.

R20 is independently selected from a hydrogen or a hydrocarbyl, selected from alkyl, alkenyl, aryl, aralkyl, alkoxycarbonyl or alkylaryl groups, and one or more combinations thereof. Said hydrocarbyl group may be linear, branched or cyclic. Said hydrocarbyl group may be substituted or unsubstituted. Said hydrocarbyl group may contain one or more heteroatoms. Preferably, said hydrocarbyl group has from 1 to 20 carbon atoms, more preferably from 1 to 12 carbon atoms, even more preferably from 1 to 6 carbon atoms. On the proviso that at least one R20 is a hydrocarbyl group. Optionally, two or three R20 groups are joined in a cyclic radical forming a heterocyclic structure.

Non-limiting examples of suitable R20 groups are: methyl, ethyl, propyl, isopropyl, butyl, isobutyl, tert-butyl, pentyl, neopentyl, hexyl, 2-methylpentyl, heptyl, octyl, isooctyl, 2-ethylhexyl, 5,5-dimethylhexyl, nonyl, decyl, isodecyl, undecyl, dodecyl, phenyl, phenethyl, methoxyphenyl, benzyl, tolyl, xylyl, naphthyl, methylnapthyl, cyclohexyl, cycloheptyl, and cyclooctyl.

Suitable examples of the hydrocarbyl aluminum compounds as co-catalyst include triisobutylaluminum, trihexylaluminum, di-isobutylaluminum hydride, dihexylaluminum hydride, isobutylaluminum dihydride, hexylaluminum dihydride, diisobutylhexylaluminum, isobutyl dihexylaluminum, trimethylaluminum, triethylaluminum, tripropylaluminum, triisopropylaluminum, tri-n-butylaluminum, trioctylaluminum, tridecylaluminum, tridodecylaluminum, tribenzylaluminum, triphenylaluminum, trinaphthylaluminum, and tritolylaluminum. In an embodiment, the cocatalyst is selected from triethylaluminum, triisobutylaluminum, trihexylaluminum, di-isobutylaluminum hydride and dihexylaluminum hydride. More preferably, trimethylaluminium, triethylaluminium, triisobutylaluminium, and/or trioctylaluminium. Most preferably, triethylaluminium (abbreviated as TEAL).

Preferably, the co-catalyst is triethylaluminum. The molar ratio of aluminum to titanium may be from about 5:1 to about 500:1 or from about 10:1 to about 200:1 or from about 15:1 to about 150:1 or from about 20:1 to about 100:1. The molar ratio of aluminum to titanium is preferably about 45:1.

For example, the molar ratio of aluminium to titanium, when the co-catalyst is triethylaluminium (Al/Ti ratio) ranges from 25 to 250.

In an embodiment, the process includes contacting the olefin with a co-catalyst. The co-catalyst can be mixed with the procatalyst (pre-mix) prior to the introduction of the procatalyst into the polymerization reactor. The co-catalyst may be also added to the polymerization reactor independently of the procatalyst. The independent introduction of the co-catalyst into the polymerization reactor can occur (substantially) simultaneously with the procatalyst feed. An external donor may also be present during the polymerization process.

### External Donor

An external electron donor may also be present in the catalyst system according to the present invention. One of the functions of an external donor compound is to affect the stereoselectivity of the catalyst system in polymerization of olefins having three or more carbon atoms.

In the invention, the external donor is a combination of Selectivity Control Agent (SCA) and Activity Limiting Agent (ALA).

Preferably, the external donor or Selectivity Control Agent (SCA) is selected from the group consisting of: dicyclopentyldimethoxysilane, di-tert-butyldimethoxysilane, methylcyclohexyldimethoxysilane, diphenyldimethoxysilane, di-n-propyldimethoxysilane, di-n-butyldimethoxysilane, isopropyltrimethoxysilane, n-ethylcyclohexyldimethoxysilane, diisopropyldimethoxysilane, diisobutyldimethoxysilane, cyclopentyltrimethoxysilane, propyltrimethoxysilane, n-propyltriethoxysilane, ethyltriethoxysilane, tetramethoxysilane, tetraethoxysilane, cyclopentylpyrrolidinodimethoxysilane, bis(pyrrolidino)-dimethoxysilane, di(isopropyl) dimethoxysilane, and bis(perhydroisoquinolino)dimethoxysilane, more preferably the SCA is selected from the group consisting of di(isopropyl) dimethoxysilane and n-propyltrimethoxysilane. For example, the external donor in the catalyst system according to the present invention may be complexed with the co-catalyst and mixed with the procatalyst (pre-mix) prior to contact between the procatalyst and the olefin. The external donor can also be added independently to the polymerization reactor. The procatalyst, the co-catalyst, and the external donor can be mixed or otherwise combined prior to addition to the polymerization reactor.

Preferably, the Activity Limiting Agent (ALA) is selected from the group consisting of: ethyl acetate, ethyl benzoate, p-ethoxy ethyl benzoate, methyl trimethylacetate, isopropyl myristate, di-n-butyl sebacate, (poly)(alkylene glycol) mono- or diacetates, (poly)(alkylene glycol) mono- or di-myristates, (poly)(alkylene glycol) mono- or di-laurates, (poly)(alkylene glycol) mono- or di-dioleates, glyceryl tri(acetate), mixed glycerides of linoleic, oleic, palmitic and stearic acids, and mixtures thereof. More preferably, the Activity Limiting Agent (ALA) is isopropyl myristate, methyl trimethylacetate, isopropyl myristate or di-n-butyl sebacate.

The ratio of Selectivity Control Agent (SCA) to Activity Limiting Agent (ALA) is in principle not critical, best results are obtained for a SCA/ALA ratio in the range from 0.1 to 20, more preferably in the range from 0.3 to 10.

The Ratio of Activity Limiting Agent (ALA) to metal can be chosen from 0.1 to 20, more preferably in the range from 0.3 to 9.0.

The process for the polymerizing propylene homopolymer or propylene-alpha-olefin copolymer according to the invention using the catalyst system according tot the invention allow to obtain a propylene-based polymer with an average meso sequence length (MSL) superior or equal to 90 when it has been polymerized at 58° C. and/or superior or equal to 80 when it has been polymerized at 94° C., and/or between 90 and 80 when it has been polymerized in between 58 and 94°;

Although the invention has been described in detail for purposes of illustration, it is understood that such detail is solely for that purpose and variations can be made therein by those skilled in the art without departing from the spirit and scope of the invention as defined in the claims.

It is further noted that the invention relates to all possible combinations of features described herein, preferred in particular are those combinations of features that are present in the claims. It will therefore be appreciated that all combinations of features relating to the composition according to the invention; all combinations of features relating to the process according to the invention and all combinations of features relating to the composition according to the invention and features relating to the process according to the invention are described herein.

It is further noted that the term ‘comprising’ does not exclude the presence of other elements. However, it is also to be understood that a description on a product/composition comprising certain components also discloses a product/composition consisting of these components. The product/composition consisting of these components may be advantageous in that it offers a simpler, more economical process for the preparation of the product/composition. Similarly, it is also to be understood that a description on a process comprising certain steps also discloses a process consisting of these steps. The process consisting of these steps may be advantageous in that it offers a simpler, more economical process.

The invention is now elucidated by way of the following examples, without however being limited thereto.

### EXAMPLES

The polymerization reactions of propylene are conducted in a 2.5 L gas phase reactor which is first dried under vacuum and 90 □C for one hour, followed by 10 cycles of flushes using an argon pressure of 0.5 barg and vacuum. Before introduction of the reactants, the reactor is cooled using a water bath to below 40 [symbol] C after which the desired amount of Selectivity Control Agent (SCA) solution in heptane is injected using a syringe under positive pressure of argon, followed by the solutions of the Activity Limiting Agent (ALA), and the cocatalyst (TEAL), both in heptane using the same injection procedure. After injection of the catalyst modifiers, the desired amount of hydrogen is introduced to the reactor, then, the reactor is heated to the desired reaction temperature, once it is reached, the catalyst, which is dispersed in purified salt (sodium chloride), is injected using propylene pressure while the reactor is under agitation at a speed of 250 rpm. Immediately after the catalyst injection, the reactor is pressurized to the desired pressure, which in this case is 8.0 barg of propylene. The pressure is regulated at the reaction pressure using a pressure control valve, and the monomer flow is recorded using a mass flow meter. The reaction is conducted for 60 minutes while regulating the reaction temperature using an external water bath connected to the jacket of the reactor. After the desired reaction time is reached, the reactor is quickly cooled down to 20 [symbol] C while venting the pressure at the same time. Finally, the polymer powder is collected, washed, and dried under vacuum before analysis.

In the following examples and comparative examples, the Ziegler-Natta Pro-catalyst is the same and prepare according to the description, the internal donor is the same and follows formula I, the Selectivity Control Agent (SCA) is n-propyltrimethoxysilane and the Activity Limiting Agent (ALA) is according to the following table:

| | |
|---|---|
| CE1 | None |
| EX1 | iso-propyl myristate |
| EX2 | methyl trimethylacetate |
| EX3 | di-n-butyl sebacate |

The following polymerisation condition and polymer properties:

| | CE1 | EX1 | EX2 | EX3 |
|---|---|---|---|---|
| Activity (kg-PP/gCat.h) at 58° C. | 3.8 | 3.1 | 1.9 | 2.3 |
| Activity (kg-PP/gCat.h) at 94° C. | 2.8 | 0.19 | 0.11 | 0.06 |
| MSL at 58° C. | 85 | 99 | 138 | 145 |
| MSL at 94° C. | 65 | 88 | 115 | 84 |
| mmmm (mol %) at 58° C. | 93 | 94 | 95 | 95 |
| mmmm (mol %) at 94° C. | 91 | 93 | 93 | 93 |
| SCA/ALA | — | 0.3 | 0.3 | 0.3 |
| Si/Ti | 3 | 3 | 3 | 3 |
| ALA/Ti | — | 9 | 9 | 9 |
| Al/Ti | 51 | 51 | 51 | 51 |
| H₂ (mol %) | 2 | 2 | 2 | 2 |

Surprisingly, the inventor find out that the process for the polymerizing propylene homopolymer or propylene-alpha-olefin copolymer according to the invention allows to obtain a Propylene homopolymer or propylene-ethylene copolymer with an average meso sequence length (MSL) superior or equal to 90 when it has been polymerized at 58° C. and/or superior or equal to 80 when it has been polymerized at 94° C., and/or between 90 and 80 when it has been polymerized in between 58 and 94°; and a pentad isotacticity of at least 93 wt. %, preferably of at least 96 wt %, wherein the pentad isotacticity is determined using 13C NMR on the polymer has been produced under a reaction temperature of 94° C. which is not reachable without the specific combination of compounds present within the catalyst system according to the invention.

### Methods

### Isotacticity ¹³C NMR

200 mg of polypropylene powder was dissolved in a 10 mm NMR tube in 3 ml at 120° C. in a 10 vol % solution of deuterated ortho-di-chlorobenzene in ortho-di-chlorobenzene. The 13C NMR spectrum was recorded on a high resolution 400 MHz Bruker instrument used for 13C NMR analysis at an operating temperature of 120° C.

The isotacticity of the mmmm pentad levels was determined from the 13C NMR spectrum in % based on the total pentad amount.

### MSL

The average meso sequence length (MSL), which indicates the length of isotactic portions in the polymer chain, is calculated from the 13C NMR spectra according to the following equation:

$$MSL = \frac{mmmm + 1.5 mrrr + 2 rmmr + 0.5 rmrm + 0.5 rmrr}{0.5 rmrm + 0.5 rmrr + rmmr + 0.5 mmmr}$$

1. A process for the polymerizing propylene homopolymer or propylene-alpha-olefin copolymer comprising the steps of:
selecting a propylene monomer and optionally one or more alpha-olefin comonomers;
selecting one or more catalyst system comprising:
one or more Ziegler-Natta procatalysts;
optionally one or more cocatalyst;
one or more internal donor according to Formula I: 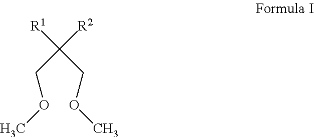
wherein R¹ is a secondary alkyl group and R² is a non-secondary alkyl group having at least 5 carbon atoms;
one or more activator;
one or more Selectivity Control Agent (SCA);
one or more Activity Limiting Agent (ALA);
wherein Ziegler-Natta procatalyst is obtain by the following step:
i) contacting a compound R⁴_{z}MgX⁴_{2-z} with an alkoxy- or aryloxy-containing silane compound to give a first intermediate reaction product, being a solid Mg(OR¹)ₓX¹₂₋ₓ, wherein: R⁴ and R¹ are each a linear, branched or cyclic hydrocarbyl group independently selected from alkyl, alkenyl, aryl, aralkyl, alkoxycarbonyl or alkylaryl groups, and one or more combinations thereof; wherein said hydrocarbyl group may be substituted or unsubstituted, may contain one or more heteroatoms; X⁴ and X¹ are each independently selected from the group of consisting of fluoride (F—), chloride (Cl—), bromide (Br—) or iodide (I—); and 0<z<2 and, 0<x<2;
ii) optionally contacting the solid Mg(OR¹)ₓX¹₂₋ₓ obtained in step i) with at least one activating compound selected from the group formed of activating electron donors and metal alkoxide compounds of formula M¹(OR²)_{v-w}(OR³)_{w} or M²(OR²)_{v-w}(R³)_{w}, to obtain a second intermediate product; wherein M¹ is a metal selected from the group consisting of Ti, Zr, Hf, Al or Si; M² is a metal being Si; v is the valency of M¹ or M² and is either 3 or 4; w<v; R² and R³ are each a linear, branched or cyclic hydrocarbyl group independently selected from alkyl, alkenyl, aryl, aralkyl, alkoxycarbonyl or alkylaryl groups, and one or more combinations thereof; wherein said hydrocarbyl group may be substituted or unsubstituted, may contain one or more heteroatoms, and preferably has from 1 to 20 carbon atoms;
iii) contacting the first or second intermediate reaction product, obtained respectively in step i) or ii), with the halogen-containing Ti-compound; the activator; and the internal electron donor
polymerizing the propylene monomer and optionally the one or more alpha-olefin comonomers, in presence of the catalyst system, which has been obtained by contacting the Ziegler-Natta procatalyst obtained in step iii) with the optional co-catalyst and the Selectivity Control Agent (SCA) in combination with an Activity Limiting Agent (ALA); via a slurry polymerization process or a gas-phase polymerization process or a solution polymerization process, in one or more reactors;
thereby producing one or more polypropylene
wherein the catalyst system has a loss of at least 35% of catalyst activity when the temperature is increased from 58 to 94° C.

2. The process according to claim 1, wherein the Selectivity Control Agent (SCA) is selected from the group comprising of dicyclopentyldimethoxysilane, di-tert-butyldimethoxysilane, ethylcyclohexyldimethoxysilane, methylcyclohexyldimethoxysilane, diphenyldimethoxysilane, diisopropyldimethoxysilane, di-n-propyldimethoxysilane, diisobutyldimethoxysilane, di-n-butyldimethoxysilane, cyclopentyltrimethoxysilane, isopropyltrimethoxysilane, n-propyltrimethoxysilane, n-propyltriethoxysilane, ethyltriethoxysilane, tetramethoxysilane, tetraethoxysilane, cyclopentylpyrrolidinodimethoxysilane, bis(pyrrolidino)-dimethoxysilane which is a donor, for example di(isopropyl) dimethoxysilane, and bis(perhydroisoquinolino)dimethoxysilane.

3. The process according to claim 1, wherein the activator is selected from the list comprising benzamides, alkylbenzoates, mono-esters, ethyl acetate, amyl acetate, butyl acetate, ethyl acrylate, methyl methacrylate, isobutyl methacrylate, methylbenzamide, dimethylbenzamide, methylbenzoate, ethylbenzoate, n-propylbenzoate, iso-propylbenzoate, n-butylbenzoate, 2-butylbenzoate, t-butylbenzoate, monoamide, ethyl benzoate, and N,N-dimethyl benzamide.

4. The process according to claim 1, wherein the Activity Limiting Agent (ALA) is selected from the group comprising of: ethyl acetate, methyl trimethylacetate, isopropyl myristate, di-n-butyl sebacate, (poly)(alkylene glycol) mono- or diacetates, (poly)(alkylene glycol) mono- or di-myristates, (poly)(alkylene glycol) mono- or di-laurates, (poly)(alkylene glycol) mono- or di-dioleates, glyceryl tri(acetate), mixed glycerides of linoleic, oleic, palmitic and stearic acids, and mixtures thereof.

5. The process according to claim 1, wherein the Activity Limiting Agent (ALA) is iso-propyl myristate, di-n-butyl sebacate, or methyl trimethylacetate.

6. The process according to claim 1, wherein the cocatalyst is selected from a list comprising hydrides, alkyls, or aryls of aluminum, lithium, zinc, tin, cadmium, beryllium, magnesium, and combinations thereof.

7. The process according to claim 1, wherein the SCA/ALA ratio is from 0.1 to 20.

8. The process according to claim 1, wherein the ratio of Activity Limiting Agent (ALA) to metal can be chosen from 0.1 to 20.

9. The process according to claim 1, wherein the process is a gas phase polymerization process.

10. The process according to claim 1, wherein the process is performed in at least one horizontal and/or vertical gas phase reactor, the reactor can be mechanically stirred.

11. The process according to claim 1, wherein the process is phthalate free and/or wherein the process is free of 9,9-bis(methoxymethyl) fluorene.

12. A propylene homopolymer or propylene-ethylene copolymer obtained by the process of claim 1, wherein it is having an average meso sequence length (MSL) superior or equal to 90 when it has been polymerized at 58° C. and/or superior or equal to 80 when it has been polymerized at 94° C., and/or between 90 and 80 when it has been polymerized in between 58 and 94°; and a pentad isotacticity of at least 93 wt. %, wherein the pentad isotacticity is determined using 13C NMR on the polymer has been produced under a reaction temperature of 94° C.

13. A biaxially oriented polypropylene (BOPP) film comprising the propylene homopolymer or propylene-ethylene copolymer of claim 12.
